(19) United States
(12) Patent Application Publication
(10) Pub. No.: US 2026/0255388 A1
(43) Pub. Date: Aug. 27, 2026

(54) SENSING BY PROXY METHOD AND APPARATUS

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/992,218

(22) PCT Filed: Jul. 11, 2022
(86) PCT No.: PCT/CN2022/105015

§ 371 Date: Jan. 8, 2025

(51) Int. Cl. H04W 74/0808; H04W 24/10; H04W 74/06

(52) U.S. Cl. CPC H04W 74/0808; H04W 24/10; H04W 74/06

(57) ABSTRACT

A sensing by proxy (SBP) measurement method and apparatus, relating to the technical field of mobile communications. The SBP measurement method comprises: in an SBP measurement process, sending a trigger frame, the trigger frame being used for instructing a sensing receiving end to send a sensing measurement result, wherein a station information field of the trigger frame does not comprise identification information of an SBP initiator (101). A method for feeding back a sensing measurement result of an SBP process is provided.

### CROSS-REFERENCE TO RELATED APPLICATION

The application is a U.S. National Stage of International Application No. PCT/CN 2022/105015 filed on Jul. 11, 2022, the entire content of which is incorporated herein by reference,

### TECHNICAL FIELD

Embodiments of the present disclosure relate to the technical field of mobile communication, and in particular, the embodiments of the present disclosure relate to a sensing by proxy method and apparatus.

### BACKGROUND

With the rapid development of mobile communication technology, Wireless Fidelity (Wi-FI) technology has made great progress in terms of transmission rate and throughput. At present, Wi-Fi technology is researched on content such as 320 Mhz bandwidth transmission, aggregation and collaboration of multiple frequency bands, etc. For example, its main application scenarios include video transmission, augmented reality (AR), virtual reality (VR), etc.

Specifically, the aggregation and collaboration of multiple frequency bands refers to the simultaneous communication between devices in 2.4 GHZ, 5.8 GHz, 6 GHz and other frequency bands. For scenarios in which devices communicate simultaneously in multiple frequency bands, a new Media Access Control (MAC) mechanism needs to be defined for management. In addition, the aggregation and coordination of multiple frequency bands is expected to support low latency transmission.

At present, in the technology of aggregation and coordination of multiple frequency bands, the maximum bandwidth supported is 320 MHZ (160 MHZ+160 MHZ). In addition, it may also support 240 MHz (160 MHz+80 MHz) and other bandwidths supported by existing standards.

Among the Wi-Fi technologies currently being studied, Wireless Local Area Network (WLAN) Sensing technology may be supported, for example, in application scenarios such as location discovery, proximity detection and presence detection in dense environments (such as home environments and enterprise environments).

### SUMMARY

The embodiments of the present disclosure provide a sensing by proxy method and apparatus.

On the one hand, the embodiments of the present disclosure provide a sensing by proxy method, which is executed by a sensing by proxy (SBP) responder. The method includes:
sending a trigger frame during a sensing by proxy procedure, where the trigger frame indicates a sensing receiver to send a sensing measurement result; where a station information field of the trigger frame does not include identification information of an SBP initiator.

On the other hand, the embodiments of the present disclosure further provide a sensing by proxy apparatus, which includes:
a sending module, configured to send a trigger frame during a sensing by proxy procedure, where the trigger frame indicates a sensing receiver to send a sensing measurement result; where a station information field of the trigger frame does not include identification information of an SBP initiator.

The embodiments of the present disclosure further provide a communication apparatus, including a memory, a processor, and a computer program stored in the memory and executable on the processor. When the processor executes the program, it implements one or more of the methods described in the embodiments of the present disclosure.

The embodiments of the present disclosure further provide a non-transitory computer-readable storage medium. A computer program is stored on the non-transitory computer-readable storage medium. When the computer program is executed by a processor, one or more of the methods described in the embodiments of the present disclosure is implemented.

Additional aspects and advantages of the embodiments of the present disclosure will be set forth in part in the description which follows, and will become apparent from the description, or may be learned by practice of the present disclosure.

### BRIEF DESCRIPTION OF THE DRAWINGS

In order to more clearly illustrate the technical solutions of the embodiments of the present disclosure, the following will briefly introduce the accompanying drawings that need to be used in the description of the embodiments of the present disclosure. Obviously, the accompanying drawings in the following description are only some embodiments of the present disclosure, for those skilled in the art, other drawings can also be obtained according to these drawings without paying creative labor

FIG. 1 is a first flowchart of a sensing by proxy method provided by an embodiment of the present disclosure;

FIG. 2 is a first schematic diagram of a first example of an embodiment of the present disclosure;

FIG. 3 is a second schematic diagram of the first example of the embodiment of the present disclosure;

FIG. 4 is a third schematic diagram of the first example of the embodiment of the present disclosure;

FIG. 5 is a schematic diagram of a second example of an embodiment of the present disclosure;

FIG. 6 is a second flowchart of the sensing by proxy method provided by an embodiment of the present disclosure;

FIG. 7 is a third flowchart of the sensing by proxy method provided by the embodiment of the present disclosure;

FIG. 8 is a schematic structural diagram of a sensing by proxy apparatus provided by an embodiment of the present disclosure, and

FIG. 9 is a schematic structural diagram of a communication apparatus provided by an embodiment of the present disclosure.

### DETAILED DESCRIPTION

The term “and/or” in the embodiments of the present disclosure describes the association relationship of associated objects, indicating that there may be three relationships. For example, A and/or B may mean: A exists alone, A and B exist simultaneously, and B exists alone. The character “/” generally indicates that the contextual objects have an “or” relationship.

The term “a plurality of” in the embodiments of the present disclosure refers to two or more, and other quantifiers are similar thereto.

Reference will now be made in detail to the exemplary embodiments, examples of which are illustrated in the accompanying drawings. When the following description refers to the drawings, unless otherwise indicated, the same numerals in different drawings indicate the same or similar elements. The implementations described in the following exemplary embodiments do not represent all implementations consistent with the present disclosure. Rather, they are merely examples of apparatuses and methods consistent with some aspects of the present disclosure as recited in the appended claims.

The terms used in the present disclosure are for the purpose of describing particular embodiments only, and are not intended to limit the present disclosure. As used in the present disclosure and the appended claims, the singular forms “a”, “said” and “the” are also intended to include the plural unless the context clearly dictates otherwise. It should also be understood that the term “and/or” as used herein refers to and includes any and all possible combinations of one or more of the associated listed items.

It should be understood that although the terms first, second, third, etc. may be used in the present disclosure to describe various information, the information should not be limited to these terms. These terms are only used to distinguish information of the same type from one another. For example, without departing from the scope of the present disclosure, first information may also be called second information, and similarly, second information may also be called first information. Depending on the context, for example, the word “if” as used herein could be interpreted as “at” or “when” or “in response to a determination.” The following will clearly and completely describe the technical solutions in the embodiments of the present disclosure with reference to the accompanying drawings in the embodiments of the present disclosure. Obviously, the described embodiments are only some of the embodiments of the present disclosure, not all of them. Based on the embodiments in the present disclosure, all other embodiments obtained by persons of ordinary skill in the art without making creative efforts belong to the protection scope of the present disclosure.

In the procedure of WLAN sensing, the identities of the station (STA) and the access point device (Access Point, AP) can usually be interchanged. For example, both can serve as the initiator device (Sensing Initiator or Sensing Transmitter). When being used as the Sensing Initiator or Sensing Transmitter, the AP can communicate with multiple STAs at the same time, but the STA does not have the above function and can only communicate one-to-one with a single responder (Sensing Responder). On the one hand, it causes a waste of spectrum resources, and on the other hand, it causes an increase in latency, and may not be able to meet latency requirements in communication scenarios with relatively high latency requirements. In order to solve this problem, a method is proposed to use AP to act for STA to perform WLAN sensing measurement, that is, Sensing By Proxy (SBP) measurement. During the SBP procedure, after the AP, as the SBP responder, acts for the SBP initiator to perform the sensing measurement, it needs to feed back the measurement result to the SBP initiator. Therefore, a way to feed back the sensing measurement result of the SBP procedure needs to be provided,

The embodiments of the present disclosure provide a sensing by proxy method and apparatus to provide a way of feeding back the sensing measurement results of the SBP procedure.

The method and the apparatus are based on the same application concept. Since the principles of the method and the apparatus to solve the problem are similar, the implementation of the apparatus and the method can be referred to each other, and the repeated details will not be given.

As shown in FIG. 1, the embodiment of the present disclosure provides a sensing by proxy method. In some embodiments, the method may be performed by a sensing by proxy (SBP) measurement responder (SBP responder or SBP responding end). The method may include the following steps.

In step 101: during a sensing by proxy procedure, a trigger frame is sent, the trigger frame being used to instruct a sensing receiver to send a sensing measurement result; where a station information field of the trigger frame does not include identification information of an SBP initiator.

As a first example, referring to FIOs. 2 to 4, the architecture of WLAN sensing and the WLAN sensing procedure to which the sensing by proxy method provided by the embodiments of the present disclosure is applied are first introduced.

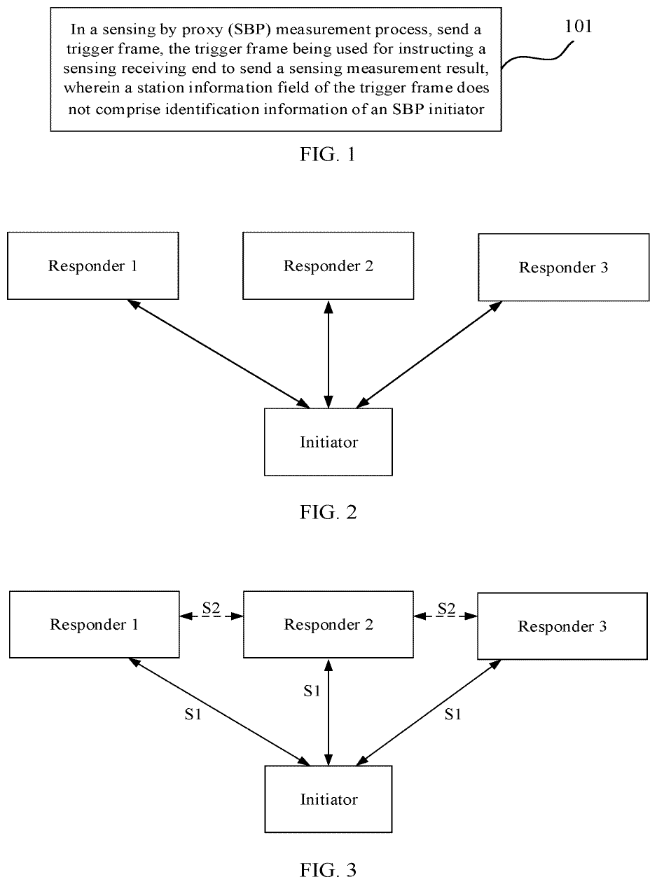

FIG. 2 shows a schematic architectural diagram of the WLAN sensing (procedure). The Sensing Initiator (or Initiator) initiates WLAN sensing (for example, initiates a WLAN sensing session), and there may be multiple sensing responders (Sensing Responders, or sensing receivers) or responders responding to the WLAN sensing, such as Responder I, Responder 2 and Responder 3 shown in FIG. 2. When the sensing initiator initiates WLAN sensing, multiple associated or un-associated sensing responders of WLAN sensing can respond.

Referring to FIG. 3, the sensing initiator and the sensing responder communicate through a communication connection, as shown by the communication connection SI; and the sensing responders communicate with each other through the communication connection S2.

Each sensing initiator may be a client (Client); each sensing responder (in this example, sensing responder 1 to sensing responder 3) may be a station device (Station, STA) or an access point device (Access Point, AP). In addition, the STA and the AP can play multiple roles in the WLAN sensing procedure. For example, in the WLAN sensing procedure, the STA can also serve as a sensing initiator, and the sensing initiator may be a sensing transmitter, a sensing receiver, either both, or neither, In the WLAN sensing procedure, the sensing responder may also be a sensing transmitter, a sensing receiver, or both.

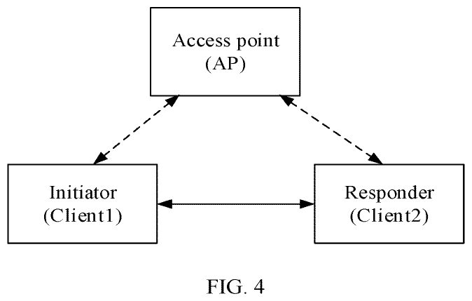

As another architecture, as shown in FIG. 4, the sensing initiator and the sensing responder may both be clients, and they can communicate by connecting to the same access point device (AP). In FIG. 4, Clienti is the sensing initiator, and Client2 is the sensing responder.

Normally, when acting as a Sensing Initiator or a Sensing Transmitter, the STA does not have the function of communicating with multiple receivers simultaneously. Therefore, a proxy device (such as an AP) is required to perform the sensing measurement on behalf of the STA, so as to improve the efficiency of sensing measurements. In the SBP scenario, the SBP initiator may participate in the subsequent sensing procedure after initiating the SBP procedure. Specifically, the AP, as a proxy of SBP, initiates the sensing measurement based on trigger frame (Triggered Based Sounding, TB). The TB sensing measurement is divided into NDPA Sounding (downlink DL) sensing and trigger frame sounding (uplink UL) procedures. The SBP initiator may participate in the NDPA sounding procedure.

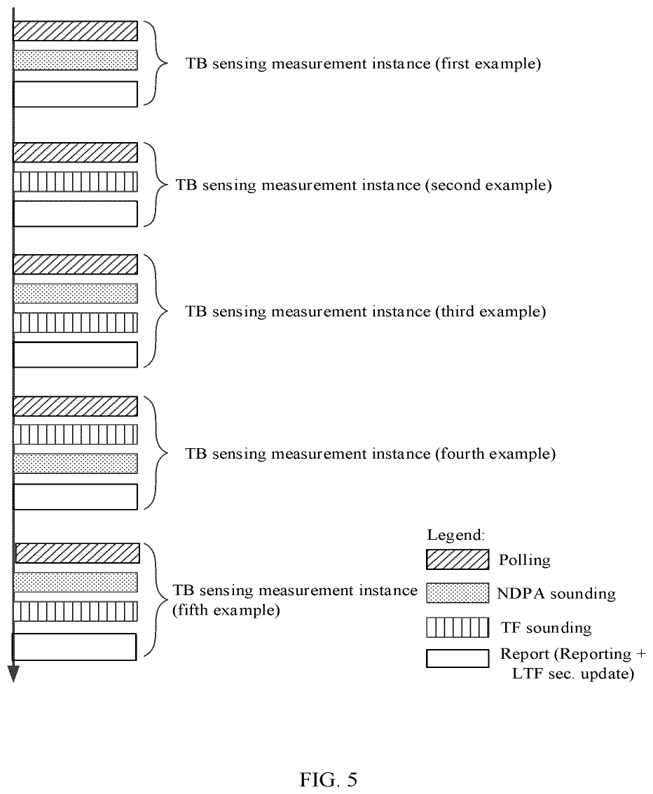

Specifically, the WLAN sensing procedure usually includes a triggered frame (Triggered Based Sounding, TB) based manner and a Non-TB based sensing manner. Specifically, the TB sensing measurement manner is that the AP is an Initiator or a Transmitter, and the Non-TB sensing measurement manner is that the STA is an Initiator or a Transmitter. In the embodiments of the present disclosure, the AP initiates TB sensing measurement during the SBP procedure; as a second example, the TB sensing procedure is shown in FIG. 5. FIG. 5 shows multiple sensing measurement instances of sensing measurement of one TB sensing procedure. In the first example to the fifth example, the sensing procedure includes polling, sounding and reporting (Reporting+LTF sec. update) procedures. In each example, sounding may only include NDPA Sounding or TF Sounding; or may include both at the same time, and the SBP initiator may participate in the NDPA Sounding procedure.

In the embodiments of the present disclosure, in the measurement report phase of the SBP scenario, the SBP responder (for example, the AP) sends a trigger frame. The trigger frame indicates the sensing receiver for sensing measurement to send the sensing measurement result. The trigger frame may be a broadcast message frame, and its receiver address is a broadcast address, and the station information field of the trigger frame does not include the identification information of the SBP initiator. In some embodiments, the identification information of the SBP initiator may be an association identifier (AID) or an un-association identifier (UID) of the SBP initiator, etc., and has the same size as the AID and is also unique. That is, the SBP initiator does not receive the trigger frame and does not send the sensing measurement result to the SBP responder.

Specifically, in the sensing procedure performed by the SBP responder as a proxy, the sensing receiver may be a station (STA), and may include an STA acting as the SBP Initiating end (SBP initiator or SBP measurement initiator). In the SBP sensing measurement, the SBP initiator needs to obtain the sensing measurement result, and the sensing measurement result is forwarded to the SBP initiator by the SBP responder. However, in the NDPA Sounding, the SBP initiator has already obtained the sensing measurement result and there is no need to forward it by the SBP responder. Therefore, the STA info field of the trigger frame in the Measurement Report phase of the embodiments of the present disclosure does not contain any information about the SBP initiator, which identifies that the SBP initiator does not need to feed back the NDPA Sounding measurement result; the AP only needs to receive the NDPA Sounding sensing measurement result(s) of other station(s) (other station is the sensing receiver other than the SBP initiator, for ease of explanation), and then forward it to the SBP initiator.

In addition, if the SBP responder (AP) triggers the SBP initiator to send a Measurement Report in the Measurement Report, the Measurement Report sent by the SBP initiator will become invalid information, resulting in a waste of spectrum resources.

In the embodiments of the present disclosure, the SBP responder sends a trigger frame during the sensing by proxy procedure, the trigger frame being used to instruct the sensing receiver to send the sensing measurement result; where the station information field of the trigger frame does not include the SBP initiator. The SBP initiator does not need to feed back the NDPA Sounding measurement result, and the SBP responder only needs to receive the NDPA Sounding sensing measurement result(s) of other station(s), and then forward it to the SBP initiator. The embodiments of the present disclosure provide a way to feed back the sensing measurement result of the SBP procedure.

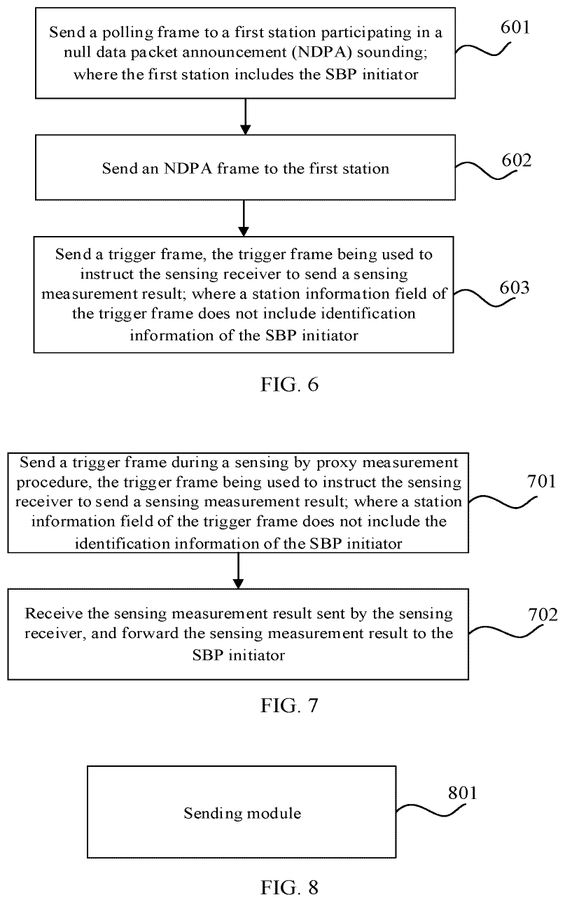

Referring to FIG. 6, an embodiment of the present disclosure provides a sensing by proxy method. In some embodiments, the method may be executed by a sensing by proxy (SBP) responder. The method may include the following steps.

In step 601, a polling frame is sent to a first station participating in a null data packet announcement (NDPA) sounding; where the first station includes the SBP initiator.

In combination with FIG. 5, in the polling phase, the AP sends a Polling frame to the first station acting as the sensing receiver, The first station includes all STAs participating in the NDPA sounding sensing measurement, that is, including the SBP initiator, so as to detect whether STAs can participate in the subsequent NDPA procedure. The Polling frame includes the resource information of CTS-to-self sent by the first station, which identifies that the SBP initiator at least participates in the NDPA sounding sensing measurement, and the SBP initiator may also participate in the TF sounding sensing measurement. If the SBP initiator participates in the NDPA sensing measurement, during the measurement report phase, the trigger frame sent by the SBP responder (AP) does not contain the identification of the SBP initiator.

In step 602, an NDPA frame is sent to the first station.

In combination with FIG. 5, in the NDPA Sounding phase, that is, the sensing measurement phase, the AP sends the NDPA frame to STAs (first station), where a Receiver Address (RA) of the NDPA frame is a broadcast address, which includes information of the SBP initiator, that is, the SBP initiator participates in NDPA Sounding.

In step 603, a trigger frame is sent, the trigger frame indicates the sensing receiver to send a sensing measurement result; where a station information field of the trigger frame does not include identification information of an SBP initiator.

The sensing receiver is the first station, and the station information field of the trigger frame does not include the identification information of the SBP initiator, that is, the SBP initiator does not receive the trigger frame, and the SBP initiator does not need to feed back the NDPA Sounding measurement result. The SBP responder only needs to receive the NDPA Sounding sensing measurement result(s) of other station(s) and then forward it to the SBP initiator, The embodiment of the present disclosure provides a sensing by proxy method. In some embodiments, the method may be executed by a sensing by proxy (SBP) responder. The method may include the following steps;
sending a polling frame to a first station participating in a null data packet announcement (NDPA) sounding; where the first station includes the SBP initiator;
if the SBP responder is associated with the SBP initiator, allocating an Association Identifier (AID) to the SBP initiator; where if the SBP initiator has established the association with the SBP responder, the AID is allocated to the STA; where in the embodiments of the present disclosure, the association may be establishing a communication connection;
if the SBP responder is unassociated with the SBP initiator, allocating an un-association identifier (UID) to the SBP initiator; where if no association is established, the UID is allocated to the SBP initiator during an SBP setup procedure (security authentication and key agreement have been completed before);
sending an NDPA frame to the first station;
sending a trigger frame, where the trigger frame indicates the sensing receiver to send the sensing measurement result; where the station information field of the trigger frame does not include the identification information of the SBP initiator.

The embodiment of the present disclosure provides a sensing by proxy method. In some embodiments, the method may be executed by a sensing by proxy (SBP) responder. The method may include the following steps:
sending a polling frame to a first station participating in a null data packet announcement (NDPA) sounding: where the first station includes the SBP initiator;
sending an NDP A frame to the first station, where a station information field of the NDPA frame includes: the identification information of the SBP initiator and a resource unit (RU) identification of the SBP initiator receiving a null data packet (NDP) frame; In some embodiments, the identification information of the SBP initiator may be the association identifier (AID) or the un-associated identifier (UID) of the SBP initiator, etc. ; the RU identification is used to indicate the resource unit (RU) of the SBP initiator receiving the null data packet (NDP) frame;
sending an NDPA frame to the first station;
sending a trigger frame, where the trigger frame indicates the sensing receiver to send the sensing measurement result; where the station information field of the trigger frame does not include the identification information of the SBP initiator.

Referring to FIG. 7, the embodiment of the present disclosure provides a sensing by proxy method. In some embodiments, the method may be executed by a sensing by proxy (SBP) responder. The method may include the following steps.

In step 701, during a sensing by proxy procedure, a trigger frame is sent, the trigger frame being used to instruct the sensing receiver to send a sensing measurement result; where a station information field of the trigger frame does not include the identification information of the SBP initiator.

In step 702, the sensing measurement result sent by the sensing receiver is received, and the sensing measurement result is forwarded to the SBP initiator.

Receiving the sensing measurement result sent by the sensing receiver means only receiving the sensing measurement result of the sensing receiver except the SBP initiator, and then the sensing measurement result is forwarded to the SBP initiator.

The embodiment of the present disclosure provides a sensing by proxy method. In some embodiments, the method may be executed by a sensing by proxy (SBP) responder. The method may include the following steps.

During the sensing by proxy procedure, a trigger frame is sent, where the trigger frame indicates the sensing receiver to send the sensing measurement result: where the station information field of the trigger frame does not include the identification information of the SBP initiator.

The sensing measurement result sent by the sensing receiver is received, and the sensing measurement result is sent to the SBP initiator; the sensing measurement result carries timestamp information, and the sensing measurement setup identifier (MSID) corresponding to the sensing measurement result includes at least one sensing measurement instance.

When the SBP responder forwards the sensing measurement result of other station, if the sensing measurement setup identifier (MSID) includes multiple (two or more) sensing measurement instances, the timestamp information is carried in the sensing measurement result, so that the SBP initiator searches for the NDP frame that is closest in time to the timestamp information after the timestamp information based on the timestamp information, so as to determine the sensing measurement instance corresponding to the sensing measurement result. It can be understood that when the SBP initiator receives the NDP frame, it will cache the time information for receiving the NDP frame. In addition, if the MSID includes one sensing measurement instance, the timestamp information does not need to be carried when forwarding the sensing measurement result.

In the embodiments of the present disclosure, the SBP responder sends a trigger frame during the sensing by proxy procedure, and the trigger frame indicates the sensing receiver to send the sensing measurement result; where the station information field of the trigger frame does not include the identification information of the SBP initiator. The SBP initiator does not need to feed back the NDPA Sounding measurement result, and the SBP responder only needs to receive the NDPA Sounding sensing measurement result(s) of other station(s), and then forward it to the SBP initiator.

Referring to FIG. 8, based on the same principle as the method provided by the embodiments of the present disclosure, the embodiment of the present disclosure also provides a sensing by proxy apparatus. The apparatus includes:
a sending module 801, configured to send a trigger frame during a sensing by proxy procedure; the trigger frame being used to instruct the sensing receiver to send a sensing measurement result; where a station information field of the trigger frame does not include identification information of the SBP initiator.

The architecture of WLAN sensing and the WLAN sensing procedure to which the communication apparatus provided by the embodiments of the present disclosure applies refer to the aforementioned first example, and the procedure of the SBP responder initiating TB sensing during the SBP procedure refers to the aforementioned second example, which will not be elaborated here.

Specifically, in the sensing procedure performed by the SBP responder as a proxy, the sensing receiver may be a station (STA), and may include the STA acting as the SBP initiator. In SBP sensing measurement, the SBP initiator needs to obtain the sensing measurement result, which is forwarded to the SBP initiator by the SBP responder, However, in NDPA Sounding, the SBP initiator has already obtained the sensing measurement result and the sensing measurement result does not need to be forwarded by the SBP responder. Therefore, the STA info field of the trigger frame in the Measurement Report phase of the embodiments of the present disclosure does not contain any information about the SBP initiator, which identifies that the SBP initiator does not need to feed back the NDPA. Sounding measurement result; the AP only needs to receive the NDPA Sounding sensing measurement result(s) of other station(s) (other station is the sensing receiver other than the SBP initiator, for ease of explanation), and then forward it to the SBP initiator.

In addition, if the SBP responder (AP) triggers the SBP initiator to send a Measurement Report in the Measurement Report, the Measurement Report sent by the SBP initiator will become invalid information, resulting in a waste of spectrum resources.

In an optional embodiment, the apparatus further includes:
a polling module, configured to, before the sending module 801 sends the trigger frame, send a polling frame to a first station participating in a null data packet announcement (NDPA) sounding; where the first station includes the SBP initiator;
an NDPA module, configured to send an NDPA frame to the first station.

In an optional embodiment, the polling module includes:
a first configuration submodule, configured to allocate an association identifier (AID) to the SBP initiator if the SBP responder is associated with the SBP initiator;
a second configuration submodule, configured to allocate an un-association identifier (UID) to the SBP initiator if the SBP responder is not associated with the SBP initiator.

In an optional embodiment, a station information field of the NDPA frame includes: the identification information of the SBP initiator and a resource unit (RU) identification of the SBP initiator receiving the null data packet (NDP) frame.

In an optional embodiment, the apparatus further includes;
a first forwarding module, configured to receive the sensing measurement result sent by the sensing receiver after the sending module 801 sends the trigger frame, and forward the sensing measurement result to the SBP initiator.

In an optional embodiment, the apparatus further includes:
a second forwarding module, configured to send the sensing measurement result to the SBP initiator; where the sensing measurement result carries timestamp information, and a sensing measurement setup identifier (MSID) corresponding to the sensing measurement result includes at least one sensing measurement instance.

In the embodiments of the present disclosure, the sending module 801 sends a trigger frame during the sensing by proxy procedure. The trigger frame indicates the sensing receiver to send the sensing measurement result; and the station information field of the trigger frame does not include the identification information of the SBP initiator The SBP initiator feeds back the NDPA Sounding measurement result, and the SBP responder only needs to receive the NDPA Sounding sensing measurement result of other station, and then forward it to the SBP initiator.

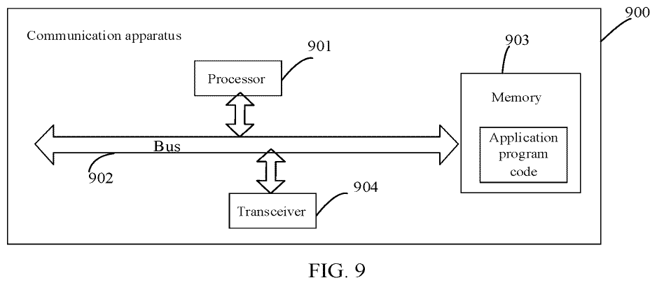

In an optional embodiment, the embodiment of the present disclosure further provides a communication apparatus, as shown in FIG. 9. The communication apparatus 900 shown in FIG. 9 may be a server, including: a processor 901 and a memory 903. The processor 901 and the memory 903 are connected, such as through a bus 902. Optionally, the communication apparatus 900 may also include a transceiver 904. It should be noted that in practical applications, the number of transceivers 904 is not limited to one, and the structure of the communication apparatus 900 does not constitute a limitation on the embodiments of the present disclosure.

The processor 901 may be a Central Processing Unit (CPU), a general-purpose processor, a Digital Signal Processor (DSP), an Application Specific Integrated Circuit (ASIC), a Field Programmable Gate Array (FPGA), or other programmable logic devices, transistor logic devices, hardware components, or any combination thereof. It may implement or execute the various illustrative logical blocks, modules and circuits described in connection with the present disclosure. The processor 901 may also be a combination that implements computing functions, such as a combination of one or more microprocessors, a combination of a DSP and a microprocessor, etc.

The bus 902 may include a path for delivering information between the above-mentioned components. The bus 902 may be a Peripheral Component Interconnect (PCI, Peripheral Component Interconnect Standard) bus or an Extended Industry Standard Architecture (EISA) bus, etc. The bus 902 can be divided into an address bus, a data bus, a control bus, etc. For ease of presentation, only one thick line is used in FIG. 9, but it does not mean that there is only one bus or one type of bus.

The memory 903 may be a Read Only Memory (ROM) or other types of static storage devices that can store static information and instructions, a Random Access Memory (RAM) or other types of dynamic storage devices that can store information and instructions, may also be an Electrically Erasable Programmable Read Only Memory (EEPROM), a Compact Disc Read Only Memory (CD-ROM) or other optical disc storage, optical disk storage (including compression optical disc, laser disc, optical disc, digital versatile disc, Blu-ray disc, etc.), magnetic disk storage medium or other magnetic storage device, or may be any other medium that are used to carry or store the desired program code in the form of instructions or data structures and can be accessed by a computer, which is not limited thereto.

The memory 903 is used to store application program codes for executing the solutions of the present disclosure, and is controlled by the processor 901 for execution. The processor 901 is used to execute the application program codes stored in the memory 903 to implement the contents shown in the foregoing method embodiments.

The communication apparatus includes but is not limited to: mobile terminals such as a mobile phone, a notebook computer, a digital broadcast receiver, a personal digital assistant (PDA), a tablet computer (PAD), a portable multimedia player (PMP), a vehicle-mounted terminal (such as a vehicle-mounted navigation terminal), and fixed terminals such as a digital TV, a desktop computer. The communication apparatus shown in FIG. 9 is only an example and should not impose any limitations on the functions and scope of use of the embodiments of the present disclosure.

The server provided by the present disclosure may be an independent physical server, or a server cluster or distributed system composed of multiple physical servers. It may also be a cloud server for providing basic cloud computing services cloud services, cloud databases, cloud computing, cloud functions, cloud storage, network services, cloud communications, middleware services, domain name services, security services, CDN, and big data and artificial intelligence platforms. The terminal may be a smartphone, a tablet, a laptop, a desktop computer, a smart speaker, a smart watch, etc., but is not limited thereto. The terminal and the server may be connected directly or indirectly through wired or wireless communication methods, which is not limited by the present disclosure.

The embodiments of the present disclosure provide a computer-readable storage medium. The computer-readable storage medium stores a computer program. When the computer program runs on a computer, the computer can execute the corresponding content in the foregoing method embodiments.

It should be understood that although various steps in the flowchart of the accompanying drawings are shown in sequence as indicated by arrows, these steps are not necessarily performed in the order indicated by arrows. Unless explicitly stated in the present disclosure, the execution of these steps is not strictly limited in order, and they can be executed in other orders. Moreover, at least some of the steps in the flowchart of the accompanying drawings may include multiple sub-steps or multiple phases. These sub-steps or phases are not necessarily executed at the same time, but may be executed at different times, and their execution order is not necessarily need to be performed sequentially, but may be performed in turn or alternately with other steps or sub-steps of other steps or at least part of the phases.

It should be noted that the computer-readable medium mentioned above in the present disclosure may be a computer-readable signal medium or a computer-readable storage medium, or any combination of the above two. The computer-readable storage medium may be, for example, but is not limited to, an electrical, magnetic, optical, electromagnetic, infrared, or semiconductor system, apparatus or device, or any combination thereof. More specific examples of the computer-readable storage medium may include, but are not limited to: an electrical connection having one or more wires, a portable computer disk, a hard drive, a random access memory (RAM), a read only memory (ROM), an Erasable Programmable Read Only Memory (EPROM or flash memory), a fiber optic, a portable compact disk read-only memory (CD-ROM), an optical storage device, a magnetic storage device, or any suitable combination of the above. In the present disclosure, the computer-readable storage medium may be any tangible medium that contains or stores a program for use by or in connection with an instruction execution system, apparatus, or device. In the present disclosure, the computer-readable signal medium may include a data signal propagated in baseband or as part of a carrier wave, carrying computer-readable program code therein. Such propagated data signals may take many forms, including but not limited to electromagnetic signals, optical signals, or any suitable combination of the above. The computer-readable signal medium may also be any computer-readable medium other than the computer-readable storage medium, and the computer-readable signal medium can send, propagate, or transmit a program for use by or in connection with an instruction execution system, apparatus, or device. The program code contained in the computer-readable medium may be transmitted using any suitable medium, including but not limited to: wire, optical cable, radio frequency (RF), etc., or any suitable combination of the above.

The above-mentioned computer-readable medium may be included in the above-mentioned communication apparatus; it may also exist independently without being assembled into the communication apparatus.

The above computer-readable medium carries one or more programs. When the one or more programs are executed by the communication apparatus, the communication apparatus executes the method shown in the above embodiments.

According to one aspect of the present disclosure, a computer program product or computer program is provided. The computer program product or computer program includes computer instructions stored in the computer-readable storage medium, The processor of the computer device reads the computer instructions from the computer-readable storage medium, and the processor executes the computer instructions, so that the computer device executes the methods provided in the above various optional implementations.

The computer program code for performing the operations of the present disclosure may be written in one or more programming languages or a combination thereof, the above programming languages including object-oriented programming languages such as Java, Smalltalk, C++, and conventional Procedural programming languages such as “C” or a similar programming language. The program code may be executed entirely on the user's computer, partly on the user's computer, as a stand-alone software package, partly on the user's computer and partly on a remote computer, or entirely on the remote computer or server. In situations involving remote computers, the remote computer can be connected to the user's computer through any kind of network, including a local area network (LAN) or a wide area network (WAN), or it can be connected to an external computer (such as being connected through Internet via an Internet service provider).

The flowcharts and block diagrams in the accompanying drawings illustrate the architecture, functionality, and operations that may be implemented by the systems, methods, and computer program products according to various embodiments of the present disclosure, In this regard, each block in the flowchart or block diagram may represent one module, segment, or portion of code that contains one or more executable instructions that implement the specified logic functions. It should also be noted that, in some alternative implementations, the functions noted in the block may occur out of the order noted in the drawings. For example, two blocks shown one after another may actually be executed substantially in parallel, or they may sometimes be executed in the reverse order, depending on the functionality involved. It will also be noted that each block in the block diagram and/or flowchart, and combinations of blocks in the block diagram and/or flowchart, can be implemented by special purpose hardware-based systems that perform the specified functions or operations, or can be implemented using a combination of specialized hardware and computer instructions.

The modules involved in the embodiments of the present disclosure can be implemented in software or hardware. The name of a module does not constitute a limitation on the module itself under certain circumstances. For example, module A can also be described as “module A used to perform operation B”.

The above description is only a description of the preferred embodiments of the present disclosure and the technical principles applied. Those skilled in the art should understand that the disclosed scope involved in the present disclosure is not limited to the technical solutions composed of specific combinations of the above technical features, but should also cover other technical solutions formed by any combination of the above technical features or their equivalent features without departing from the above disclosed concept, for example, a technical solution formed by replacing the above feature with the technical feature

1. A sensing by proxy method, executed by a sensing by proxy (SBP) responder, wherein the method comprises:
sending a trigger frame during a sensing by proxy procedure, wherein the trigger frame indicates a sensing receiver to send a sensing measurement result; wherein a station information field of the trigger frame does not comprise identification information of an SBP initiator.

2. The sensing by proxy method according to claim 1, wherein before sending the trigger frame, the method further comprises:
sending a polling frame to a station participating in a null data packet announcement (NDPA) sounding measurement; wherein the station comprises the SBP initiator; and
sending an NDPA frame to the station.

3. The sensing by proxy method according to claim 2, wherein sending the polling frame to the station participating in the null data packet announcement (NDPA) sounding measurement comprises:
in a case that the SBP responder is associated with the SBP initiator, allocating an association identifier (AID) to the SBP initiator;
in a case that the SBP responder is unassociated with the SBP initiator, allocating an un-association identifier (UID) to the SBP initiator.

4. The sensing by proxy method according to claim 2, wherein a station information field of the NDPA frame comprises: the identification information of the SBP initiator and a resource unit (RU) identification of the SBP initiator receiving a null data packet. (NDP) frame.

5. The sensing by proxy method according to claim 1, wherein after sending the trigger frame, the method further comprises:
receiving the sensing measurement result sent by the sensing receiver;
forwarding the sensing measurement result to the SBP initiator.

6. The sensing by proxy method according to claim 5, further comprising:
sending the sensing measurement result to the SBP initiator; wherein the sensing measurement result carries timestamp information, and a sensing measurement setup identifier (MSID) corresponding to the sensing measurement result comprises at least one sensing measurement instance.

7. (canceled)

8. A communication apparatus, comprising a memory, a processor and a computer program stored in the memory and executable on the processor, wherein when the processor executes the program, the processor is configured to:
send a trigger frame during a sensing by proxy procedure, wherein the trigger frame indicates a sensing receiver to send a sensing measurement result: wherein a station information field of the trigger frame does not comprise identification information of an SBP initiator

9. A non-transitory computer-readable storage medium, wherein a computer program is stored on the computer-readable storage medium, and when the computer program is executed by a processor, the processor is configured to:
send a trigger frame during a sensing by proxy procedure, wherein the trigger frame indicates a sensing receiver to send a sensing measurement result: wherein a station information field of the trigger frame does not comprise identification information of an SBP initiator

10. The communication apparatus according to claim 8, wherein the processor is further configured to:
send a polling frame to a station participating in a null data packet announcement (NDPA) sounding measurement; wherein the station comprises the SBP initiator; and
send an NDPA frame to the station.

11. The communication apparatus according to claim 10, wherein the processor is further configured to:
in a case that an SBP responder is associated with the SBP initiator, allocate an association identifier (AID) to the SBP initiator;
in a case that the SBP responder is unassociated with the SBP initiator, allocate an un-association identifier (UID) to the SBP initiator,

12. The communication apparatus according to claim 10, wherein a station information field of the NDPA frame comprises: the identification information of the SBP initiator and a resource unit (RU) identification of the SBP initiator receiving a null data packet (NDP) frame.

13. The communication apparatus according to claim 8, wherein the processor is further configured to:
receive the sensing measurement result sent by the sensing receiver;
forward the sensing measurement result to the SBP initiator.

14. The communication apparatus according to claim 13, wherein the processor is further configured to:
send the sensing measurement result to the SBP initiator; wherein the sensing measurement result carries timestamp information, and a sensing measurement setup identifier (MSID) corresponding to the sensing measurement result comprises at least one sensing measurement instance.

15. The non-transitory computer-readable storage medium according to claim 9, wherein the processor is further configured to:
send a polling frame to a station participating in a null data packet announcement (NDPA) sounding measurement; wherein the station comprises the SBP initiator; and
send an NDPA frame to the station.

16. The non-transitory computer-readable storage medium according to claim 15, wherein the processor is further configured to:
in a case that an SBP responder is associated with the SBP initiator, allocate an association identifier (AID) to the SBP initiator;
in a case that the SBP responder is unassociated with the SBP initiator, allocate an un-association identifier (UID) to the SBP initiator.

17. The non-transitory computer-readable storage medium according to claim 15, wherein a station information field of the NDPA frame comprises; the identification information of the SBP initiator and a resource unit (RU) identification of the SBP initiator receiving a null data packet (NDP) frame.

18. The non-transitory computer-readable storage medium according to claim 9. wherein the processor is further configured to:
receive the sensing measurement result sent by the sensing receiver;
forward the sensing measurement result to the SBP initiator.

19. The non-transitory computer-readable storage medium according to claim 18, wherein the processor is further configured to:
send the sensing measurement result to the SBP initiator; wherein the sensing measurement result carries timestamp information, and a sensing measurement setup identifier (MSID) corresponding to the sensing measurement result comprises at least one sensing measurement instance.
